(19) United States
(12) Patent Application Publication
(10) Pub. No.: US 2020/0337330 A1
(43) Pub. Date: Oct. 29, 2020

(54) METHOD OF ROASTING RAW COFFEE BEANS USING MICROWAVE HEATING

(71) Applicant: JUNG HWA MQD. CO., LTD., Seoul (KR)

(72) Inventor: Kwan SUNG, Seoul (KR)

(21) Appl. No.: 16/759,834

(22) PCT Filed: Aug. 23, 2018
(86) PCT No.: PCT/KR2018/009744

§ 371 Date: Apr. 28, 2020

(30) Foreign Application Priority Data
Nov. 16, 2017 (KR) 10-2017-0153061

(51) Int. Cl. A23F 5/04; A23N 12/12

(52) U.S. Cl. CPC A23F 5/04; A23N 12/125

(57) ABSTRACT

The present invention provides a method for controlling the roasting of coffee using microwave heating, the method being characterized in that roasting is completed in a coffee roasting device by: using raw coffee bean physical property data, pre-stored in a microcomputer or PLC, and coffee roasting operation information, input through an input unit, to calculate a roasting time (roasting retention time), an external air flow (hot air) temperature, and an appropriate microwave output corresponding to the temperature to achieve the target roasting step; and continuously operating a magnetron to input microwave energy. The continuous coffee roasting device using microwave heating comprises a microwave generation device intended to be used as a main heat source for roasting raw coffee beans and a microwave output control unit capable of controlling the microwave output of the microwave generation device, a hot air system providing an external air flow around the raw beans as hot air to prevent a cooling effect from occurring due to the external air when heating the raw beans with microwaves is installed, a transfer device continuously supplying the raw coffee beans and inducing the discharge of the coffee beans following roasting is provided, a shielding device for preventing microwaves from leaking out through open portions as the inlet and outlet portions of the roasting chamber (heating chamber and resonant cavity) must be open due to the raw coffee beans continuously entering and exiting the roasting chamber is installed, and a roasting device operation unit capable of controlling the overall operation of the continuous microwave roasting device is included.

### TECHNICAL FIELD

The present invention relates to a method of roasting raw coffee beans using microwave heating, and more specifically, to a brand-new method of roasting raw coffee beans using microwave heating, which may address issues with conventional surface heating and microwave heating.

### BACKGROUND ART

Well known and widely in use are coffee roasting methods, such as direct-fired roasting, hot air roasting, and a combination thereof, depending on how to supply heat. Such conventional ways generate heat using gas or other fuels and heat raw coffee beans and perform surface heating, a sort of indirect heating, for roasting raw coffee beans.

Microwave heating-based coffee roasting has recently been developed. FIG. 1 illustrates an example of coffee roasting using microwaves and hot air in a rotating drum installed inside, as disclosed in Korean Patent Number 10-1779297.

As disclosed in Korean Patent No. 10-1779297, a material inlet 101 is formed in the top of a case 100, and an outlet 102 is formed in the bottom. A rotating drum 10 is horizontally installed inside, and holes are formed in the surface of the rotating drum 10, and a material inlet 12 is formed in one side thereof. A microwave device 60 is installed on one side of the case 100, and a suction unit 70 for sucking up gas generated from the case 100 are installed on one side of the case 100. Upon roasting raw coffee beans, drying first proceeds. At this time, a heating source for drying is cool air supplied through a cool air supply hole 51 formed in the bottom of the box 50. The output of microwaves is controlled to vary from 30 W to 1,000 W, and the temperature of hot air ranges 10° C. to 200° C. The roasting time ranges from 30 seconds to one hour, and the rotating drum 10 spins at 0.5 rpm to 1.5 rpm. A humidity sensor is installed at the suction unit to allow the relative humidity measured to be controlled in a range from 40% to 60%. Under such conditions, roasting of raw coffee beans proceeds.

Conventional surface heating roasters mostly include a rotating drum for evenly roasting raw coffee beans. According to this way, raw coffee beans are put in the drum, and the external wall of the drum is heated or hot air is blown into the drum. During the roasting process, some samples are taken out and observed with the naked eye to determine the state of roasting.

However, the conventional surface heating has the following issues.

Since the conventional coffee roasting adopts surface heating, which is a kind of indirect heating, the degree of roasting differs between the surface and center of raw coffee beans. This causes uneven physical, chemical variations in coffee roasting.

Surface heating-based roasting suffers from low heating efficiency and conventional direct-fired or hot air roasting has been known to give a relatively low efficiency of about 25% to 30%.

Conventional coffee roasting processes also suffer from low productivity. Some recent large-scale coffee roasters enable rapid roasting at a high temperature ranging from about 400° C. to about 450° C. but have difficulty in managing roasting quality.

Such issues with the conventional coffee roasting processes are considered inevitable from adopting surface heating and, to address, a fundamental change needs to be made to the heating source and heating way.

Further, conventional microwave heating comes with the following issues.

Korean Patent No. 10-1779297 discloses drying raw coffee beans using cool air. To dry out the water in the raw coffee beans which exists as bound water, the temperature of the water should reach, at least, 100° C. or more. However, although the raw coffee beans are heated up to 100° C. or more by microwaves, the heated raw coffee beans may be cooled down due to a flow of cool air (assumed to be about 40° C. or less), and thus, drying may take longer and proceed in an inefficient manner.

It is known that the temperature of hot air is set to 10° C. to 200° C. so that roasting is ended when the temperature of raw coffee beans reaches 210° C. to 225° C. although it may be varied depending on the degree of roasting. Given this, upon microwave heating-based roasting, raw coffee beans are heated by microwaves, but the surface of raw coffee beans may be cooled down due to the external air flow, which is at a lower temperature, around the raw coffee beans, thus causing unevenness in temperature between the surface and inside of raw coffee beans. According to the prior art, as a means for controlling hot air, the relative humidity of the discharged air is measured and the relative humidity is rendered to remain in a range form 40% to 60% while roasting. The prior art proposes a range of hot air temperature from 100° C. to 200° C. If the temperature of the hot air is less than 100° C., it is possible to control using the relative humidity. However, if the temperature of hot air falls within 100° C. to 200° C., overheated vapor may occur, and hot air control using the relative humidity may cause severe errors. That is, the techniques disclosed in Korean Patent No. 10-1779297 lack technical features capable of achieving normal coffee roasting.

### DETAILED DESCRIPTION OF INVENTION

### Technical Problems

The present invention has been developed to address the foregoing issues and aims to provide a method of roasting raw coffee beans using microwave heating to address the issues with the conventional art that lacks technical features capable of achieving normal coffee roasting.

The present invention applies microwave heating, known as volumetric heating, as heating source for roasting raw coffee beans. Microwave heating, as volumetric heating, heats raw coffee beans by self heating of raw coffee beans based on microwaves absorbed to raw coffee beans, thereby allowing the surface and inside to be simultaneously heated. In other words, roasting of raw coffee beans via simultaneous heating of the surface and inside makes no or very little difference in physical or chemical variation in the raw coffee beans and, as compared with conventional surface heating-based roasting, leads to a change to creation of chemical substances containing the flavor and aroma of coffee and, after roasting, provides a distinct taste.

According to the present invention, there is provided a microwave output control system that may set a temperature of external air (hot air) and a proper temperature of raw coffee beans appropriate in a target roasting step upon roasting using microwave heating of raw coffee beans. Further, the present invention aims to provide a method of roasting raw coffee beans using microwave heating, which may maximize the roasting quality of raw coffee beans per step, achieve rapid roasting, and maximize roasting energy efficiency by automatically controlling the microwave output control system with micom/PLC computation based on such conditions as, e.g., kind of raw coffee beans, amount of raw coffee beans loaded, temperature of external air, and temperature of coffee beans roasted.

Means to Address Problems

To achieve the above objects, according to the present invention, a method of roasting raw coffee beans using microwave heating comprises inputting roasting data of the raw coffee beans, computing a roasting process for the raw coffee beans, operating a roaster and a hot air system, detecting a temperature of hot air from the hot air system, computing a microwave output for roasting the raw coffee beans, supplying the raw coffee beans to a roasting chamber of the roaster, and applying the microwave output to the raw coffee beans and roasting the raw coffee beans by the hot air and microwaves.

The temperature of the hot air for achieving a target roasting time and a roasting time and the microwave output corresponding to the hot air are computed using operation information for coffee roasting input through an input unit and physical property data for the raw coffee beans stored in a micom/PLC to continuously operate a magnetron to apply microwave energy to thereby complete the roasting of the raw coffee beans.

Upon roasting the raw coffee beans, the temperature of the hot air is set to range from 210° C. to 250° C., and the microwave energy corresponding to the temperature of the hot air is a product of an output of a magnetron, which is a microwave generator, and a microwave heating constant X, wherein the temperature of the hot air is expressed as a linear function: (T_{∞})=a (constant)*the microwave heating constant (X)+b (constant), wherein the microwave heating constant is computed using the hot air function, and the microwave energy is determined, and wherein an operation of the magnetron is controlled using the microwave energy

The calorie of the raw coffee beans=total calorie by hot water+energy of microwaves applied. The calorie Q of roasting the raw coffee beans: Q=U*A * (T∞−TC)+EM. The microwave energy EM applied is: EM=X*PM, where U, A, T∞, TC, and EM, respectively, are the heat transfer coefficient, the heating area, temperature of hot water, temperature of raw coffee beans, and energy of microwaves applied, and X is the microwave heating constant, and PM is the output of the magnetron which is the microwave generator. The microwave heating constant is determined as: T∞=a*X+b.

a and b are constants. The microwave heating constant may be automatically computed according to the temperature of hot air, thus obtaining a and b. The energy of microwaves needed for roasting the raw coffee beans based on a and b is applied.

### Effects of Invention

It has been identified that, as compared with conventional surface heating-based coffee roasting, microwave heating-based roasting according to the present invention made changes in physical or chemical properties of raw coffee beans, in particular, changes in the components or composition giving the flavor or aroma of coffee, and that a distinct flavor and aroma was identified from coffee beans roasted according to the present invention.

The present invention adopts volumetric roasting using microwaves. As compared with the conventional surface roasting which is of low efficiency (known to be 25% to 30%), the volumetric roasting-based microwave roasting of the present invention enables high-efficiency (about 47%) roasting and save energy by about 17% to 22%.

Conventional coffee roasting mostly adopts a discrete process. However, the microwave heating-based coffee roasting of the present invention may be configured in either or both a discrete or/and continuous manner. In particular, continuous microwave heating-based coffee roasting achieves better productivity and constant or even roasting quality. While conventional discrete coffee roasting is known to take a roasting time of 8 minutes to 9 minutes, the microwave heating-based coffee roasting of the present invention may finish roasting within 6 minutes, shortening the roasting time by about 25%.

### BRIEF DESCRIPTION OF DRAWINGS

FIG. 1 is a view schematically illustrating a conventional coffee roasting process using microwaves and hot air;

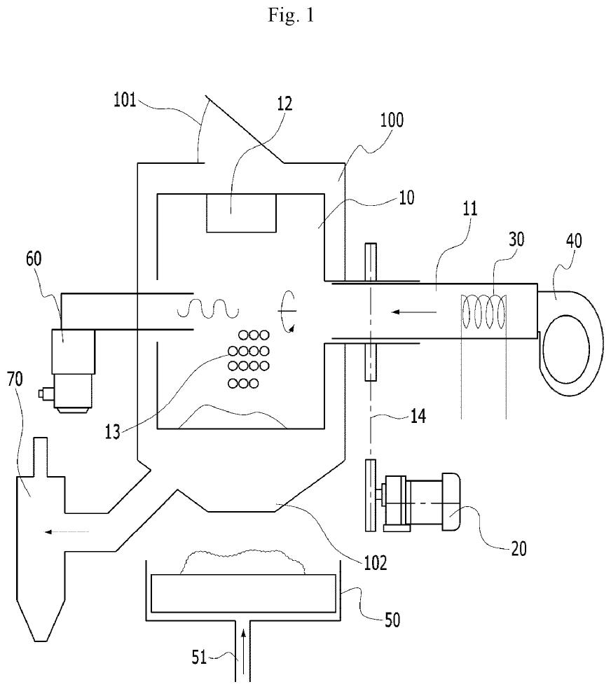

FIG. 2 is a view schematically illustrating a structure of a continuous raw coffee beans roaster used for a method of roasting raw coffee beans using microwave heating according to the present invention;

FIG. 3 is a view schematically illustrating a structure of a discrete raw coffee beans roaster used for a method of roasting raw coffee beans using microwave heating according to the present invention;

FIG. 4 is a view illustrating a configuration for operating a coffee roaster using microwave heating according to the present invention;

FIG. 5 is a flowchart illustrating a method of roasting raw coffee beans using continuous microwave heating according to the present invention; and

FIG. 6 is a flowchart illustrating a method of roasting raw coffee beans using discrete microwave heating according to the present invention.

### BEST MODE FOR PRACTICING INVENTION

Hereinafter, embodiments of the present disclosure are described in detail with reference to the accompanying drawings. The objectives, features, and advantages of the present invention will be readily appreciated from the detailed description taken in conjunction with the accompanying drawings. When determined to make the subject matter of the present invention unclear, the detailed description of the known configurations or functions may be skipped.

Such denotations as “first,” “second,” “A,” “B,” “(a),” and “(b),” may be used in describing the components of the present invention. These denotations are provided merely to distinguish a component from another, and the essence of the components is not limited by the denotations in light of order or sequence. When a component is described as “connected,” “coupled,” or “linked” to another component, the component may be directly connected or linked to the other component, but it should also be appreciated that other components may be “connected,” “coupled,” or “linked” between the components.

Referring to the drawings, according to the present invention, there is provided a coffee roaster. The coffee roaster includes a microwave generator, a microwave output controller, a hot air system, a transporting device, a shielding device, and a roaster manipulating unit. The coffee roaster may adopt continuous microwave heating. The microwave generator may be used as a main heating source for roasting raw coffee beans. The microwave output controller may control the microwave output of the microwave generator. The hot air system creates hot air as external air flow around the raw coffee beans to prevent the raw coffee beans from being cooled down due to the external air upon microwave-heating the raw coffee beans. The transporting device continuously supplies raw coffee beans and, after roasting, discharges the raw coffee beans. The shielding device prevents leakage of electromagnetic waves through an opened inlet and outlet through which raw coffee beans continuously enter or exit a roasting chamber (heating chamber, resonance cavity). The roaster manipulating unit may control the overall operation of the continuous microwaving-type roaster. According to the present invention, there is provided a method of roasting raw coffee beans using microwave heating, in which a temperature of external air (hot air) for achieving a target roasting step and a roasting time (roasting retention time) and a proper microwave output corresponding to the temperature of external air are computed using physical property data for the raw coffee beans previously stored in a microm or PLC and operation information about coffee roasting input via an input unit, and a magnetron is continuously operated to supply microwave energy to perform roasting.

Meanwhile, the raw coffee bean roasting method of the present invention may adopt a coffee roaster using discrete microwave heating. The raw coffee bean roaster using discrete microwave heating includes a microwave generator, a microwave output controller, a hot air system, and a manipulating unit for controlling the overall operation of the roaster, as its basic components, as does the continuous microwave heating-based roaster. The roasting chamber (heating chamber) of the discrete microwave heating-based roaster loads up raw coffee beans and proceeds with roasting and may be shaped as a rotating drum for even heating of the raw coffee beans.

According to the present invention, the raw coffee bean roaster using discrete microwave heating is used. Typically, the roasting chamber (heating chamber) of the discrete microwave heating-based coffee roaster is shaped as a drum that may spin for even heating of the loaded raw coffee beans. A temperature of external air (hot air) for achieving a target roasting step and a roasting time (roasting retention time) and a proper microwave output corresponding to the temperature of external air are computed using physical property data for the raw coffee beans previously stored in a microm or PLC and operation information about coffee roasting input via an input unit, and a magnetron is continuously operated to supply microwave energy to perform roasting.

Upon coffee roasting using microwave heating, the temperature of external air (hot air) is set to a range from 210° C. to 250° C., and microwave energy corresponding to the temperature of hot air may be the product of the output of the magnetron, which is the microwave generator, and a heating constant X (i.e., microwave heating constant X*output of magnetron). The microwave heating constant X has a correlation with the temperature of hot air and may be computed from the linear equation “hot air temperature (Tx)=a(constant) microwave heating constant (X)+b(constant)”. As such, the microwave energy as supplied is computed and is used to control the operation of the magnetron.

According to the present invention, the raw coffee bean roasting method uses the continuous raw coffee bean roaster. The continuous raw coffee bean roaster includes a roasting chamber for loading radiation conductor, a conveyor belt, a microwave generator, a hot air system, a microwave output controller, and a roaster manipulating unit.

The roasting chamber is shaped as a tunnel through which raw coffee beans may pass. The roasting chamber has an inlet and an outlet. The electromagnetic shielding devices are installed at the inlet and outlet of the roasting chamber.

The conveyor belt passes through the inside of the roasting chamber. The conveyor belt passes under the bottom of the roasting chamber. The conveyor belt is operated by a known driving means as is a continuous track. As the conveyor belt operates like a continuous track, the conveyor belt may move from the inlet of the roasting chamber to the outlet of the roasting chamber.

The microwave generator is a device for generating microwaves to be applied to raw coffee beans, and the microwave generator may be installed inside the roasting chamber. Preferably, the microwave generator is installed on the ceiling facing the bottom of the roasting chamber.

The hot air system is installed inside the roasting chamber. The hot air system may be installed in an internal space between the ceiling and bottom of the roasting chamber by a supporting means, e.g., brackets.

The microwave output controller is connected with the microwave generator to control the microwave generator to generate microwaves. The microwave output controller may be installed outside the roasting chamber.

The roaster manipulating unit is connected with the microwave generator via the microwave output controller and is connected also with the hot air system. The manipulation of the microwave generator and hot air system may be controlled by the roaster manipulating unit.

According to the present invention, a method of roasting raw coffee beans includes the steps of inputting roasting data, computing, driving a roaster and a hot air system, detecting the temperature of hot air, computing the output of microwaves, supplying raw coffee beans, and applying the output of microwaves.

In the step of inputting roasting data, data for raw coffee beans for roasting is input. According to the present invention, the raw coffee beans are roasted using a continuous raw coffee bean roaster or a discrete raw coffee bean roaster. The data for raw coffee beans is input by the roaster manipulating unit of the continuous raw coffee bean roaster or discrete raw coffee bean roaster (hereinafter, collectively referred to as a raw coffee bean roaster for convenience). The data for raw coffee beans includes the kind of raw coffee beans and the amount of raw coffee beans supplied. However, the data for raw coffee beans primarily means the kind of raw coffee beans.

In the computation step, a roasting process for raw coffee beans is computed. The roasting process for raw coffee beans may be performed by the roaster manipulating unit. Further, a main controller of the raw coffee bean roaster may be configured to perform the roasting process for raw coffee beans.

In the step of driving the roaster and hot air system, the overall raw coffee bean roaster is operated while the hot air system is simultaneously operated.

In the step of detecting the temperature of hot air, the temperature of hot air supplied from the hot air system to the inside of the roasting chamber is detected. The temperature of hot air may be detected by a hot air detecting sensor provided inside the roasting chamber.

In the step of computing the output of microwaves, an output of microwaves for roasting raw coffee beans is computed. The output of microwaves is computed. The output of microwaves may be computed by the main controller of the raw coffee bean roaster. The main controller may include a microwave output computing unit to compute the output of microwaves.

In the step of supplying the raw coffee beans, raw coffee beans are supplied into the roasting chamber of the roaster. The raw coffee beans are injected through the inlet of the roasting chamber. The raw coffee beans are loaded on the conveyor belt.

In the step of supplying the output of microwaves, the output of microwaves is applied to the raw coffee beans, and the raw coffee beans are roasted by the microwaves along with hot air. The microwave generator outputs microwaves, and the hot air system supplies hot air.

According to the present invention, the method of roasting raw coffee beans computes the temperature of hot air for achieving a target roasting step and a roasting time (roasting retention time) and a proper microwave output corresponding to the temperature of hot air using physical property data for the raw coffee beans stored in a microm or PLC and operation information about coffee roasting input via an input unit and continuously operates the magnetron to supply microwave energy, thereby completing the roasting of raw coffee beans. At this time, the physical property data for the raw coffee beans and the operation information for coffee roasting are input by an operation condition input unit provided in the roaster manipulating unit. Further, the roasting time means the roasting retention time, and the hot air means external flowing air (in other words, the hot air supplied from the hot air system). The microwave energy means the output of microwaves.

The present invention relates to a method of roasting raw coffee beans using microwave heating which is operated with the temperature of hot air in a range from 210° C. to 250° C. upon roasting raw coffee beans.

The microwave energy corresponding to the temperature of hot air may be the product of the output of the magnetron, which is the microwave generator, and a heating constant X (i.e., microwave heating constant X*output of magnetron). The microwave heating constant X may be computed from the linear equation “hot air temperature (T_{∞})=a(constant)*microwave heating constant (X)+b(constant)” and thus the microwave energy is computed and the operation of the magnetron is controlled using the microwave energy.

The calorie of the raw coffee beans=total calorie by hot water+energy of microwaves applied. The calorie Q of roasting the raw coffee beans is as follows:

Q=U*A*(T∞−TC)+EM (1)

Further, the energy EM of microwaves applied is as follows:

EM=X*PM (2)

Where U, A, T∞, TC, and EM, respectively, are the heat transfer coefficient, the heating area, temperature of hot water, temperature of raw coffee beans, and energy of microwaves applied, and X is the microwave heating constant, and PM is the output of the magnetron which is the microwave generator.

The microwave heating constant, which is a core factor in the present invention, is determined by the following equation:

T∞=a*X+b (3)

a and b are constants. The microwave heating constant may be automatically computed according to the temperature of hot air, thus obtaining a and b. The energy of microwaves needed for roasting the raw coffee beans based on a and b is applied.

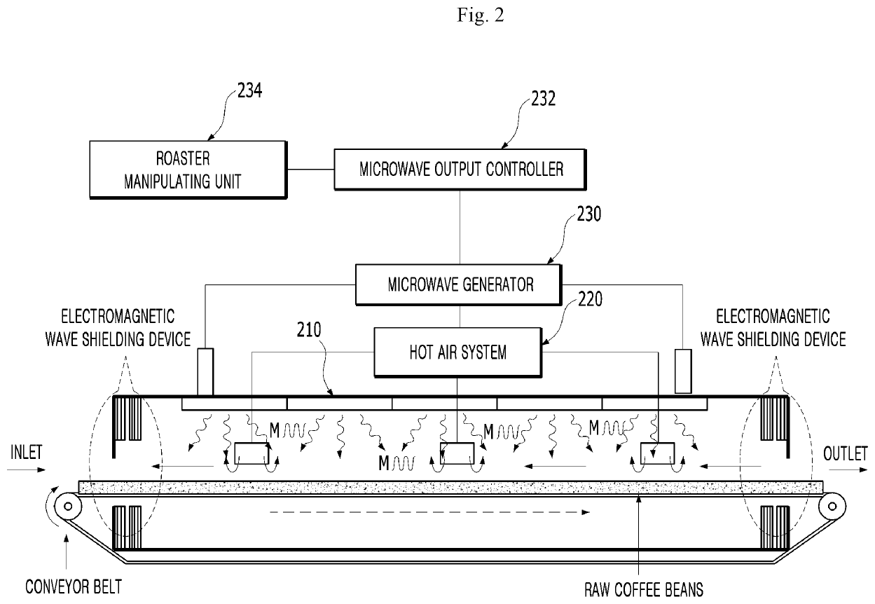

FIG. 2 is a view schematically illustrating a continuous raw coffee bean roaster using microwave heating. The continuous raw coffee bean roaster has been described. The continuous raw coffee bean roaster is described below in greater detail.

The continuous raw coffee bean roaster includes a microwave generator that is used as a main heating source for roasting raw coffee beans and a microwave output controller that may control the microwave output of the microwave generator. There is also provided a hot air system that forms the external air flow around the raw coffee beans with hot air to prevent the raw coffee beans from being cooled down due to the external air upon micro-heating the raw coffee beans. There is also provided a conveyor belt that continuously supplied raw coffee beans and, after roasting, discharges the raw coffee beans.

For raw coffee beans to continuously enter or exit the roasting chamber (heating chamber, resonance cavity), the roasting chamber has an open inlet and outlet, and electromagnetic wave shielding devices are installed at the inlet and outlet to prevent leakage of electromagnetic waves through the inlet and outlet. A roaster manipulating unit is also provided to control the overall operation of the continuous raw coffee bean roaster.

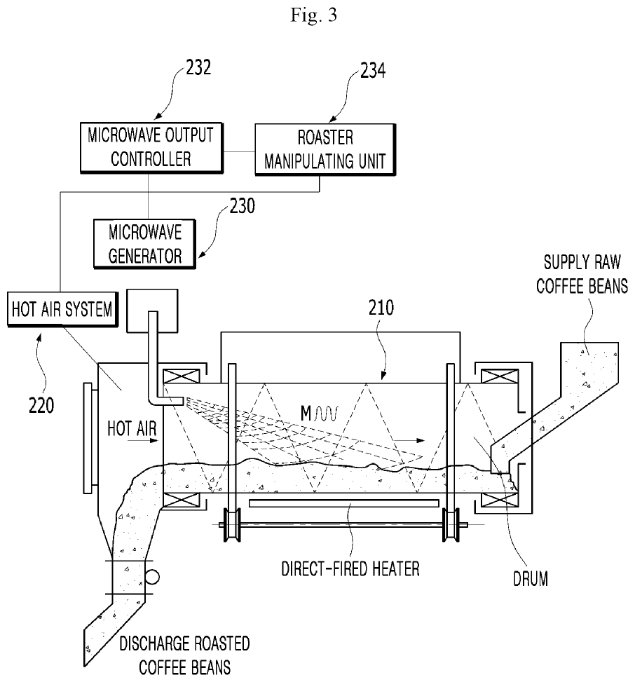

FIG. 3 is a view schematically illustrating a discrete raw coffee bean roaster using microwave heating. Like the continuous raw coffee bean roaster, the discrete raw coffee bean roaster includes a microwave generator, a microwave output controller, a hot air system, and a manipulating unit for controlling the overall operation of the roaster, as basic components. The roasting chamber (heating chamber) of the discrete microwave heating-based roaster loads up raw coffee beans and proceeds with roasting and may be shaped as a rotating drum for even heating of the raw coffee beans.

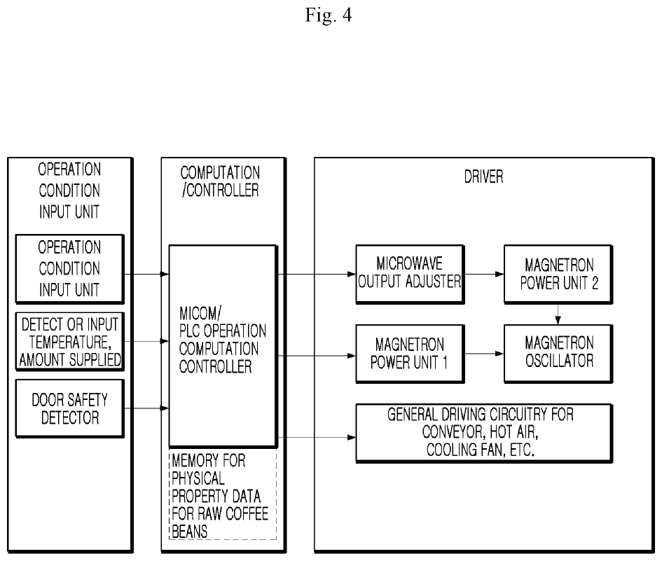

The configuration of the manipulating unit of the present invention, for operating the microwave heating-based coffee roaster of FIGS. 2 and 3 is shown in FIG. 4. FIG. 4 is a view illustrating a configuration of operating a coffee roaster using microwave heating according to the present invention, which includes an input unit, a computation/controller, and a driver. The input unit is provided for inputting conditions for raw coffee beans for roasting raw coffee beans or conditions for performing general functions of the roaster and includes a means for detecting or inputting the temperature of raw coffee beans and the amount of raw coffee beans supplied upon roasting the raw coffee beans and a door safety detector for ensuring safety when opening/closing a door of the roasting chamber (heating chamber) for maintenance of the roaster. Signals from the door safety detector are transferred to a micom/PLC of the computation/controller. The micom/PLC controls the operation of the roaster using conditions or signals from the input unit and data from an embedded memory. The driver drives or operates the roaster based on instructions from the micom/PLC. The driver includes general driving circuitry for driving a motor for cooling the magnetron, which is the microwave generator of the roaster, driving a motor for driving the conveyor for loading and, after roasting, discharging raw coffee beans, and a hot air driver for forming hot air of external air flow around the raw coffee beans to prevent the raw coffee beans from being cooled down due to the external air flow upon micro-heating the raw coffee beans, and a microwave adjuster for adjusting the output of microwaves, which is a core feature of the present invention, magnetron power unit 1 (supplying filament power of the magnetron) and magnetron power unit 2 for driving the magnetron. The micom/PLC includes a memory storing physical property data per kind of raw coffee beans and heating property data per coffee roasting step, for automated computation of the output of microwaves applied upon roasting raw coffee beans, and in some cases, the memory may be provided outside.

According to the present invention, there is provided a method of roasting raw coffee beans using microwaves, which upon roasting raw coffee beans using a continuous microwave coffee roaster or discrete microwave coffee roaster, adopts automated computation by the micom/PLC for proper roasting control according to the kind of raw coffee beans and the target roasting step, continuous operation of the magnetron according to the results of computation, and completion of roasting. A most important feature of the present invention is to complete roasting by computing a proper output of microwaves for roasting and roasting time (roasting retention time) using the physical property data for raw coffee beans pre-stored in the micom/PLC and operation information for coffee roasting input via the input unit and continuously operating the magnetron. Of course, the coffee roasting process may be varied depending on the kind of raw coffee beans, the temperature determined for roasting step (corresponding to the target roasting step), and the amount of raw coffee beans supplied.

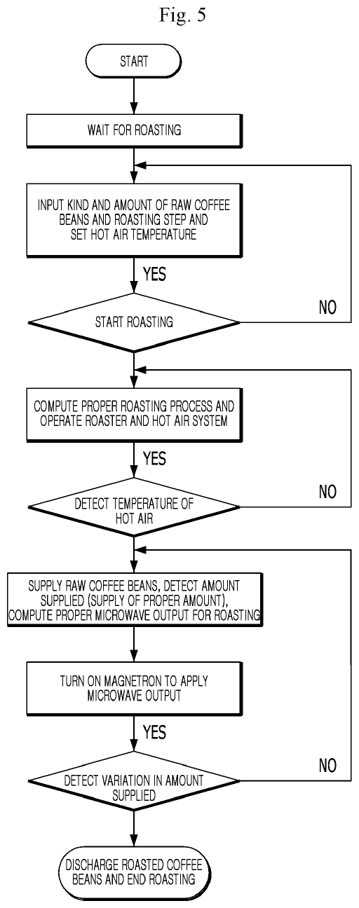

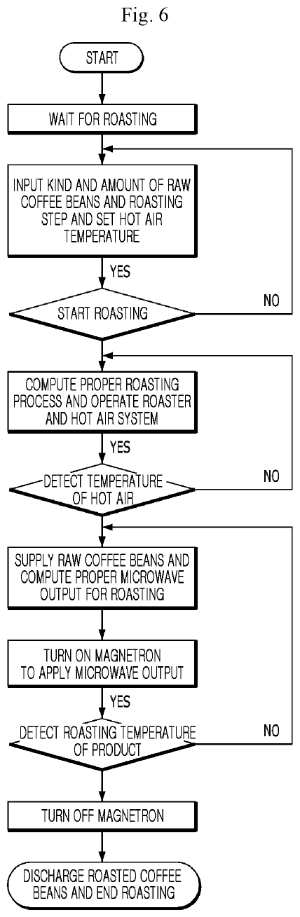

According to the present invention, there is provided a continuous coffee roaster using microwave heating. The method of operation according to the present invention, which is schematically shown in FIGS. 5 and 6, is described below in detail.

Upon starting the microwave coffee roaster, if the kind and physical properties of raw coffee beans and a target roasting step (step 8 or step 3) and a throughput are input to the operation condition input unit, basic operation conditions for roasting are generated (step of inputting roasting operation conditions). Here, an important operation condition is the temperature of hot air and has a close relationship with the temperature of raw coffee beans that reaches the target roasting step. For example, if the temperature of raw coffee beans for achieving the target roasting step is 215° C., the temperature of raw coffee beans is increased up to the roasting coffee bean temperature by microwave heating. If the temperature of external air flow is lower than the coffee temperature, cooling may occur at the surface of the raw coffee beans. Thus, a temperature difference may occur between the surface and inside of the raw coffee beans, causing an uneven overall roasting quality. If the temperature of external air flow is higher than the target coffee temperature, the surface of raw coffee beans may be over-roasted as compared with the inside due to heating by the hot air. That is, if coffee roasting is performed using microwave heating as a main heating source, the target roasting coffee temperature for achieving the target roasting step needs to be optimally harmonized with the temperature of external air flow (hot air). Generally, the temperature of raw coffee beans which determines the coffee roasting step ranges from 200° C. to 240° C., representing the lowest to highest step of the roasting. Such temperature range makes a slight difference depending on the kind of roaster and the kind of raw coffee beans. The coffee temperature corresponding to the roasting step for raw coffee beans used typically for beverages is known to range from 210° C. to 225° C., and this is also subject to changes depending on the properties of coffee roasting. The present invention adopts microwave heating as a main heating source for coffee roasting. Since self heating (volumetric heating of the raw coffee beans is caused by microwave heating so that the temperature of raw coffee beans rises, the temperature may easily reach the target roasting temperature. Thus, the temperature of external air (hot air) was experimentally determined to maintain uniform coffee roasting quality by keeping the raw coffee beans evenly heated on the surface and inside. The temperature hot air was set to have a range from 210° C. to 250° C. If the roasting conditions are set as above, the basic operation conditions of the roaster are shown on the manipulating unit and, with them, the roaster may be operated. Any change may be made to vary the roasting quality, which also belongs to the scope of the present invention. However, the variation in hot air temperature is maintained to be in a range from 210° C. to 250° C.

If the above-described conditions are determined, raw coffee beans are supplied, and microwaves are applied to the roasting chamber (heating chamber, cavity), and coffee roasting using microwave heating proceeds. If the temperature of raw coffee beans reaches the target temperature based on measurement by a temperature detecting means capable of measuring the temperature of raw coffee beans, roasting is ended, and the raw coffee beans are discharged. In the case of continuous-type roasting, proper operation conditions of the adjuster related to achieving the target roasting quality, such as the speed of conveyor, or applying microwaves to the roaster to meet the condition to reach the target roasting temperature using a temperature detecting means installed at the outlet are established, and coffee roasting is continuously performed. The most important feature in the operation of the roaster may be application of a proper output of microwave that matches the target roasting temperature, hot air temperature, and properties of raw coffee beans, which are related to achieving the target coffee roasting quality. Determining a proper output of microwaves which is a core feature of the present invention is described below in detail.

if roasting is performed by increasing the temperature of raw coffee beans, the drying of moisture in the raw coffee beans first occurs. The moisture in the raw coffee beans is included as bound water. At this time, as drying proceeds, so does a rise in temperature of raw coffee beans due to falling rate drying. Then, even after the target roasting temperature is reached and roasting is done, a trace of moisture remains in the roasted raw coffee beans. This process undergoes a very complicated thermal change mechanism. The energy budget in this process may be simplified as follows: energy budget of raw coffee beans=calorie of temperature rise for drying raw coffee beans+calorie of temperature rise up to target roasting+calorie of evaporated moisture” and the total calorie consumed for roasting raw coffee beans may be expressed as “calorie for roasting raw coffee beans=total calorie by hot air+energy of microwaves applied.” This may be expressed as in equation 1.

As shown in equation 1, the main heating source necessary for roasting raw coffee beans is microwave energy applied, and it may also be shown that the temperature of external hot air serves as a heating source for roasting. That is, it may be identified that the temperature of hot air is a critical factor in determining the magnitude of energy of microwaves applied.

The energy EM of microwaves applied is expressed as in (2) above. Here, X is the microwave heating constant, and P_{M} is the output of the magnetron which is the microwave generator. Upon coffee roasting using microwave heating, the microwave heating constant X, as compared with equation (1), is correlated with the temperature T_{∞} of hot air, and the microwave heating constant needs to be experimentally determined depending on the temperature of hot air. Thus, according to the present invention, the microwave heating constant was experimentally determined by equation (3).

T_{∞}=a·X+b (3)

Here, a and b are constants, and the temperature of hot air and the microwave heating constant are related as a linear function.

According to the present invention, to determine the microwave heating constant X, microwave heating-based coffee roasting was performed on Brazilian arabica green beans (Cerrado NY.2 (Fine cup)) under the conditions shown in the following table.

TABLE 1

| | unit | spec 1 | spec 2 |
|---|---|---|---|
| weight of raw coffee beans | kg/hr | 61.9 | 70.7 |
| initial moisture content | % wb | 9.94 | 9.94 |
| moisture content after roasting | % wb | 1.19 | 1.12 |
| temperature of raw coffee beans | °C. | 10 | 10 |
| target roasting temperature | °C. | 220 | 220 |
| temperature of hot air | °C. | 230 | 250 |
| calorie necessary for roasting | kcal/hr | 7,508.0 | 8,605.4 |
| raw coffee beans | | | |
| output of microwaves | kW | 15.510 | 14.513 |
| microwave heating constant | | 0.56288 | 0.68947 |

The microwave heating constant corresponding to the roasting hot air temperature was computed using equation (3) and the experimental results shown in the above table and, thus, a proper level of microwave energy necessary for microwave heating-based coffee roasting was able to be applied. The following table shows microwave heating constants corresponding to various hot air temperatures using equation (3).

TABLE 2

| hor air temperature (° C.) | microwave heating constant |
|---|---|
| 230 | 0.56288 |
| 250 | 0.68947 |
| a | b |
| 157.99 | _ 141.07 |
| hor air temperature (° C.) | microwave heating constant |
| 225 | 0.53123 |
| 230 | 0.56288 |
| 235 | 0.59453 |
| 240 | 0.62618 |
| 245 | 0.65782 |
| 250 | 0.68947 |

The present invention is characterized by determining the microwave heating constant corresponding to the hot air temperature. The microwave heating constant may be automatically computed by the micom/PLC. The process of determining the constants a and b is described below in detail.

230=a*0.56288

250=b*0.68947

By the above two equations, a=157.99, b=141.07.

Thus, if the temperature of hot air is 225° C. as shown in Table 2 above, the microwave heating constant is 0.53123 and, if the temperature of hot air is 230° C., the microwave heating constant is 0.56288. As such, the constants a and b are obtained and, depending on the kind of raw coffee beans, the hot air temperature and the microwave heating constant are determined, and hot air and microwaves are supplied to the raw coffee beans. By the formula, the constants a and b are automatically computed to determine and supply the temperature of hot air and microwave output suitable for the raw coffee beans to be roasted, which is a core feature of the present invention.

In microwave heating-based coffee roasting, a factor causing variations to the roasting quality of the surface of raw coffee beans is the temperature of external air flow (hot air temperature). Thus, the microwave heating constant properly corresponding to various hot air temperatures as shown in the following table is automatically computed depending on the hot air temperature to determine and supply the microwave energy necessary for achieving the optimal coffee roasting quality. Thus, the present invention is expected to significantly contribute to continuously maintaining the quality and achieving the best coffee roasting quality.

### Results of the Present Invention

In roasting raw coffee beans, microwave heating is used as a heating source for roasting. For even roasting quality between the surface and inside of the raw coffee beans, hot air is used as an assistant heating source, and microwave energy properly corresponding thereto is automatically computed, thereby enabling automated application of microwave energy. The results of roasting raw coffee beans using the method of the present invention are as follows.

The coffee roasting method using microwave heating of the present invention was applied to Brazilian arabica raw coffee beans (Cerrado NY.2(Fine cup)).

The conventional roasting method was performed on the same kind of raw coffee beans. The samples roasted in the same step (dark-medium roasting, CITY) by the conventional method and the microwave heating coffee roasting of the present invention were compared in terms of physical and chemical properties, and thereby, the roasting quality of the results of the roasting of the present invention was verified. The measurement of the physical and chemical properties of the roasting samples were performed in Chonnam National University Food Processing & Preservation Laboratory and National Instrumentation Center for Environmental Management at Seoul National University.

1) Samples Resultant from Coffee Roasting of the Present Invention

The resultant samples from coffee roasting according to the present invention are differentiated as in Table 3.

TABLE 3

| | | apparent specific | | | temp. | | | |
|---|---|---|---|---|---|---|---|---|
| | | gravity (kg/m3) | | | of | | | |
| Agtron | | before | after | | hot air | roasting time | | |
| NO | roasting step | roasting | roasting | roasting method | ° C. | min | | |
| | | 60.1 | CITY | 723 | 350 | conventional | direct- | 13 |
| | | | | | | direct-fire | fire | |
| 60.8 | CITY | 723 | 345 | hot air + | 230 | 8 | | |
| | (dark/medium | | | microwave heating | | | | |
| | roasting | | | | | | | |
| 53.8 | CITY | 723 | 335 | hot air + | 250 | 7 | | |
| | (dark/medium | | | microwave heating | | | | |
| | roasting | | | | | | | |

As shown in Table 3, as results of measurement using an Agtron meter in the step of roasting raw coffee beans, the raw coffee beans using the conventional direct-fired roasting are identified as 60.1, and the raw coffee beans using microwave heating are identified as 60.8, 53.8, which means the dark-medium (CITY) roasting step. 13 minutes were consumed for roasting using the conventional method, and 7 minutes for roasting according to the present invention. The roasting time using microwave heating may be shortened up to six minutes.

2) Results of Physical Property Measurement

The results of physical property measurement on roasted raw coffee beans using the conventional direct-fired roasting and the microwave heating roasting of the present invention are as shown in Table 4.

TABLE 4

| | Moisture | | | |
|---|---|---|---|---|
| | content | | | |
| Samples | (%) | L | a | b |
| Green bean | 9.94 | 58.45 | 1.61 | 13.75 |
| Ag. NO 60.1_conventional | 1.40 | 27.27 | 3.86 | 4.06 |
| direct-fire roasting | | | | |
| Ag. NO 60.8_microwave + | 1.19 | 27.32 | 4.03 | 4.29 |
| hot air | | | | |
| Ag. NO 53.8_microwave + | 1.12 | 26.86 | 3.44 | 3.54 |
| hot air | | | | |

* Chromaticity was measured by the colorimeter (CM-3500d, Minolta Co., Ltd Japan), and the resultant values were expressed as L (lightness), a (redness), and b (yellowness). As shown in Table 4 above, the post-roasting moisture content was somewhat high when surface heating roasting was performed, meaning that the drying in the inside of the raw coffee beans was insufficient. When roasted by microwave heating, the moisture content was reduced due to even drying on the surface and inside by the self heating, i.e., volumetric heating, of raw coffee beans by microwaves, and thus, the goal the present invention seeks was achieved.

3) Results of Measurement of Chlorogenic Acid, Caffeine, and Trigonelline Contents

The results of measurement on the chlorogenic acid, caffeine, and trigonelline contents of roasted raw coffee beans using the conventional direct-fired roasting and the microwave heating roasting of the present invention are as shown in Table 5.

Chlorogenic acid is known to be reduced in content due to a rise temperature upon roasting. As shown in Table 5, in the same degree of roasting, the chlorogenic acid content was higher in microwave heating-based roasting than the conventional direct-fired roasting. This shows that the microwave heating-based roasting allows roasting to proceed with the self heating of raw coffee beans by microwaves even without the need for increasing the temperature of hot air for roasting.

Caffeine is also known to be decreased in content as roasting proceeds. it may be shown that microwave heating-based roasting eliminates the need for roasting the temperature of hot air and keeps the caffeine content high.

Trigonelline is an aromatic substance that causes a chemical change as roasting temperature rises. Microwave heating-based roasting leads to volumetric heating that allows a temperature rise to occur evenly on the surface and inside of the raw coffee beans. Thus, it may be identified that microwave heating-based roasting reduces the content of trigonelline.

As such, comparison as to changes in content of the basic ingredients of coffee, such as chlorogenic acid, caffeine, and trigonelline, reveals that, as compared with the conventional surface heating-based roasting, the microwave heating-based roasting of the present invention causes changes in the content of the basic ingredients and thus the present invention presents effects.

4) Results of Measurement of Total Phenol Content and Antioxidant Activity

The results of measurement on the total phenol content and antioxidant activity on roasted raw coffee beans using the conventional direct-fired roasting and the microwave heating roasting of the present invention are as shown in Table 6.

It may be identified from Table 6 that the total phenol content is somewhat higher in the microwave heating-based roasting than in the conventional direct-fired roasting. It is also identified that the values of DPPH(1,1-diphenyl-2-picrvlhvdrazyl) and FRAP(Ferric reducing antioxidant power) are higher in the microwave heating-based roasting than in the conventional roasting.

5) Results of Measurement of Organic Acids

The results of measurement on organic acids on roasted raw coffee beans using the conventional direct-fired roasting and the microwave heating roasting of the present invention are as shown in Table 7.

Table 7 above shows the results of measurement of the content of organic acids after roasting. It may be identified that as the roasting gets stronger, the content of organic acids decreases as already known. It may be identified from comparison as to the content of organic acids between the sample (Ag. NO 60.1) roasted by the conventional direct-fired roasting and the sample (Ag. NO 60.8) roasted by the microwave heating-based roasting of the present invention that the content of organic acids is overall low when roasted using the microwave heating, meaning that the inside of the raw coffee beans was properly roasted by the microwave heating. Further, among the organic acids, quinic acid is produced primarily by thermal decomposition of chlorogenic acid and may be identified to match the results of measurement on the content of chlorogenic acid. It is known that the content of organic acids after roasting represents the flavor of coffee. When replacing the conventional surface heating with the volumetric heating of the present invention as heating source of roasting, changes in the content of organic acids were caused as shown in the tables, and it may be identified that microwave heating-based coffee roasting of the present invention leads to distinct values over the conventional roasting.

6) Results of Measurement on Volatile Aromatic Ingredients

The results of measurement on the volatile aromatic ingredients on roasted raw coffee beans using the conventional direct-fired roasting and the microwave heating roasting of the present invention are as shown in Table 8.

Table 8 shows the results of measurement on aromatic ingredients of raw coffee beans after roasting using gas chromatography and mass spectrometer (GC-MS) and, upon analysis, about 55 kinds of aromatic ingredients were detected, but only 20 among them were shown in the table. As shown in the table, the raw coffee beans (Ag. NO 60.1) roasted by the conventional direct-fired roasting and the raw coffee beans (Ag. NO 60.8) roasted by the microwave heating-based roasting of the present invention show some similarity in detecting the aromatic ingredients but significant differences in some ingredients.

Table 9 shows a summary for per-ingredient variations in the aromatic ingredients detected after roasting using microwave heating and the conventional roasting and flavors corresponding to the ingredients.

TABLE 9

| | | microwave | |
|---|---|---|---|
| | conventional | heating | |
| ingredients | roasting | roasting | Flavor |
| Acetone | up | down | Sour |
| Furan | up | slightly up | Burnt |
| | | slightly down | |
| 2-Butanone | up | down | Buttery |
| 2,3- | significantly | slightly down | Buttery |
| Pentanedione | down | remain constant | |
| Pyridine | down | up | Smoky |
| Butanal, | down | slightly up | Malty → slightly |
| 2-methyl- | | | diluted fruity |

As shown in FIG. 9, differences in some ingredients are shown between the coffee roasting using the microwave heating of the present invention and the conventional roasting. These results come from the fact that microwave heating, as volumetric heating, heats raw coffee beans by self heating of raw coffee beans based on microwaves absorbed to raw coffee beans to thereby allow the surface and inside to be simultaneously heated, and roasting is performed in harmony with the external environment, i.e., hot air. In other words, roasting of raw coffee beans via simultaneous heating of the surface and inside makes no or very little difference between the surface and inside, in physical or chemical variation in the raw coffee beans and, as compared with conventional surface heating-based roasting, leads to a change to creation of chemical substances containing the flavor and aroma of coffee and, after roasting, provides a distinct taste. Some specific embodiments of the present invention have been described above. However, the spirit and scope of the present invention are not limited to the specific embodiments and it will be appreciated by one of ordinary skill in the art that various changes and modification may be made thereto without departing from the gist of the present invention.

As the above-described embodiments are provided to fully convey the category of the present invention to one of ordinary skill in the art, the embodiments should be interpreted as exemplary but not limiting, and the scope of the present invention is defined by the appended claims.

1. A method of roasting raw coffee beans using microwave heating, the method comprising:
inputting roasting data of the raw coffee beans;
computing a roasting process for the raw coffee beans;
operating a roaster and a hot air system;
detecting a temperature of hot air from the hot air system;
computing a microwave output for roasting the raw coffee beans;
supplying the raw coffee beans to a roasting chamber of the roaster; and
applying the microwave output to the raw coffee beans and roasting the raw coffee beans by the hot air and microwaves.

2. The method of claim 1, wherein the temperature of the hot air for achieving a target roasting time and a roasting time and the microwave output corresponding to the hot air are computed using operation information for coffee roasting input through an input unit and physical property data for the raw coffee beans stored in a micom/PLC to continuously operate a magnetron to apply microwave energy to thereby complete the roasting of the raw coffee beans.

3. The method of claim 2, wherein upon roasting the raw coffee beans, the temperature of the hot air is set to range from 210° C. to 250° C., and the microwave energy corresponding to the temperature of the hot air is a product of an output of a magnetron, which is a microwave generator, and a microwave heating constant X, wherein the temperature of the hot air is expressed as a linear function: (T_{∞})=a (constant)*the microwave heating constant (X)+b (constant), wherein the microwave heating constant is computed using the hot air function, and the microwave energy is determined, and wherein an operation of the magnetron is controlled using the microwave energy
